(19) United States
(12) Patent Application Publication
(10) Pub. No.: US 2010/0032085 A1
(43) Pub. Date: Feb. 11, 2010

(54) METHOD FOR PRODUCING SELF-SUPPORTING MEMBRANES

(76) Inventors: Nicolas Sousbie, Grenoble (FR); Bernard Aspar, St. Ismier (FR); Chrystelle Lagahe Blanchard, Crolles (FR)

Correspondence Address: EDWARDS ANGELL PALMER & DODGE LLP, P.O. BOX 55874, BOSTON, MA, 02205, US

(21) Appl. No.: 12/564,112

(22) Filed: Sep. 22, 2009

Related U.S. Application Data
(63) Continuation of application No. PCT/IB2008/000781, filed on Mar. 25, 2008.

(30) Foreign Application Priority Data
Mar. 23, 2007 (FR) 0754011

(51) Int. Cl. B32B 38/10

(52) U.S. Cl. 156/247

(57) ABSTRACT

The disclosure relates to methods and systems for separating a membrane from a substrate. In accordance with a preferred embodiment, the method includes applying at least one member to the membrane by way of an adhesive, wherein the adhesive is applied to substantially less than the entirety of the surface of said membrane which is not facing the substrate. The method further includes separating at least a part of the membrane from the substrate by applying a force to the at least one member.

### CROSS-REFERENCE TO RELATED APPLICATIONS

This patent application is a continuation of and claims priority to International Application No. PCT/IB2008/000781, filed Mar. 25, 2008, which in turn claims priority to French Patent Application No. 0754011, filed on Mar. 23, 2007. Each of the aforementioned patent applications in incorporated by reference herein in its entirety.

### BACKGROUND

1. Field of the Invention

The present invention relates to methods for producing self-supporting membranes from materials such as detachable semiconductor on insulator (“SeOl”) substrates and silicon on insulator (“SOI”) substrates. Such techniques preferably lead to a superficial layer being separated or detached from its substrate, wherein the structure exhibits a weakened interface between the superficial layer and the substrate.

2. Description of Related Art

In various microelectronic, optoelectronic and electronic applications, it is advantageous to be able to detach a layer of semiconductor material from a substrate, whether or not the layer has been processed, in order to obtain a self-supporting layer. Moreover, in certain applications it may be advantageous to form such a layer, and to transfer the layer onto a final substrate.

Various techniques have been developed for separating or detaching a semiconductor layer from its initial support. The most commonly known means include mechanically thinning the initial support substrate, or chemically etching the initial support substrate. A combination of the mechanical thinning with the chemical etching can also be carried out. Although these methods lead to the withdrawal of the initial support, they also lead to its destruction.

Other means have been made available for weakening a particular zone of the substrate in order to detach the structure.

For example, WO 02/084721 describes a method for producing a detachable substrate comprising an interface with two different zones in term of mechanical strength. This interface can be obtained by different means, for example by bonding two surfaces prepared in different ways, or by a weakened embedded layer or by a intermediate porous layer. The detachment is thus either mechanical, with the use of blades or a liquid jet, or chemical.

However, all the aforementioned techniques are not suitable for producing self-supporting layers, more especially when the layers are thin, for example between several nanometres and several microns in thickness. Indeed, the introduction of a blade, or of any other opening system at the interface is not possible for relatively thin detachable semiconductor layers.

It is for this reason that techniques such as those described in document FR 2 848 723 have been made available. The technique described in this document employs a tool comprising two gripping elements temporarily fixed on each of the wafers to be separated, which are bent by an actuator in a controlled manner in order to separate the two wafers.

Another technique includes bonding an adhesive film (similar to adhesive tape) over the whole surface of the front face of a SOI substrate, followed by applying a tractive force on the adhesive film. Since the bonding energy of the adhesive film is higher than the bonding energy of the interface, the SOI is separated from the substrate and remains bonded to the adhesive film. A self-supporting membrane having the thickness of the initial SOI is thus obtained. The adhesive film is then separated from the membrane by chemical, mechanical or thermal action, or by the application of a UV beam if the film is UV sensitive.

However, the two techniques referenced above can only be applied to membranes of small thickness, from several hundred nanometres in thickness to several microns in thickness (typically ˜3 μm). This is because the adhesive film or the gripping element generate or impose a deformation on the membrane during separation of the membrand. Membranes of small thickness are more flexible and can undergo this deformation without rupturing.

In the case of an SOI substrate with such layers of small thickness (<3 microns), the stress generated in the membrane by the deformation of the adhesive film or the gripping element is sufficiently low to avoid rupture of the film—the film is deformed more easily because of the small thickness. In contrast, in the case of a thick SOI (thickness >3 microns, obtained by the BSOI technique for example), the stress generated in the membrane is greater due to its greater thickness. The membrane accordingly can not undergo the deformations imposed by the film or by the gripping plate. Therefore, the membrane breaks during the separation.

Finally, no previously known techniques are believed to lead to a transfer of a film or a membrane as disclosed herein. Thus, there still remains a continued need in the art for improved processing of materials such as SOI and SeOl materials that overcome the aforementioned disadvantages. The present disclosure provides a solution for these problems.

### SUMMARY OF THE DISCLOSURE

Advantages of the present invention will be set forth in and become apparent from the description that follows. Additional advantages of the invention will be realized and attained by the methods and systems particularly pointed out in the written description and claims hereof, as well as from the appended drawings.

To achieve these and other advantages and in accordance with the purpose of the invention, as embodied herein, the invention includes a method for separating a membrane from a substrate. The method includes fixing at least one adhesive on only a portion of the surface of the membrane, and then separating the membrane, or a portion thereof by way of application of a force on the adhesive, such as by a tractive force, among others.

In accordance with one embodiment, one or more adhesive film(s) can be bonded over less than the entirety of the layer, or surface, to be removed. Rather, such film(s) are preferably bonded locally on one or more zone(s) of the layer or surface. Such local bonding facilitates the initiation of the separation or detachment.

In accordance with another embodiment, the membrane can have been initially bonded by molecular adhesion with the substrate or joined with the substrate by way of a bonding layer, or by way of a substrate that was previously treated in order to increase its level of weakening.

In accordance with a further aspect, the membrane can be of a semiconductor material or a piezoelectric material or a ferroelectric material. For example, the membrane can include a weakly doped or strongly doped silicon. By way of further example, the membrane can include AsGa, Ge, SiC, GaN, InP, LiNbO₃ or LiTaO₃. The membrane may comprise a mono-layer or a multi-layer structure. The membrane may also include a processed layer.

Exemplary methods provided in accordance with the invention can produce large-area membranes, for example circular membranes having a diameter between 100 mm and 300 mm.

In accordance with a further embodiment, the separation step can be initiated by a chemical techniques applied laterally to the membrane prior to separation.

In accordance with a further aspect, the membrane can have a thickness greater than several microns. Preferably, the membrane has a thickness greater than 3 microns. Preferably, the membranes produced are self-supporting, and are thicker than 3 microns, and are detachable from SOI substrates. The resulting self-supporting membrane can be used after separation in that form. In accordance with a variant, the separated membrane can be transferred onto a final support.

In accordance with still another embodiment, a weakened zone can be formed in the membrane prior to separation of the membrane. The separation of at least a part of the membrane preferably takes place along this weakened zone. This weakened zone can be produced, for example, by ionic or atomic implantation, before or after bonding of the membrane and the substrate.

Preferably, the interface between the membrane and the substrate has a controlled energy in order to facilitate the detachment of the membrane. Alternatively or additionally, the interface between the substrate and the membrane can include a material selected in order to facilitate the detachment of the membrane.

It is to be understood that the foregoing general description and the following detailed description are exemplary and are intended to provide further explanation of the disclosed embodiments.

The accompanying drawings, which are incorporated in and constitute part of this specification, are included to illustrate and provide a further understanding of the disclosed methods, systems and resulting structures. Together with the description, the drawings serve to explain principles of the disclosed embodiments.

### BRIEF DESCRIPTION OF THE DRAWINGS

FIGS. 1A, 1B and 2 illustrate a first exemplary method provided in accordance with the present disclosure.

FIGS. 3A, 3B and 4 illustrate a second exemplary method provided in accordance with the present disclosure.

FIG. 5 illustrates a further representative method in accordance with the present disclosure using a plurality of adhesives.

FIGS. 6A and 6B illustrate formation of a fracture plane in accordance with certain aspects of the present disclosure.

FIG. 7 represents a membrane separated by a method according to the invention transferred onto a substrate.

### DETAILED DESCRIPTION OF PARTICULAR EMBODIMENTS

Reference will now be made in detail to the present preferred embodiments, examples of which are illustrated in the accompanying drawings and accompanying text. Exemplary methods are described herein with reference to a BSOI substrate, but can be generalised to any type of detachable SeOl (semiconductor on insulator) substrate.

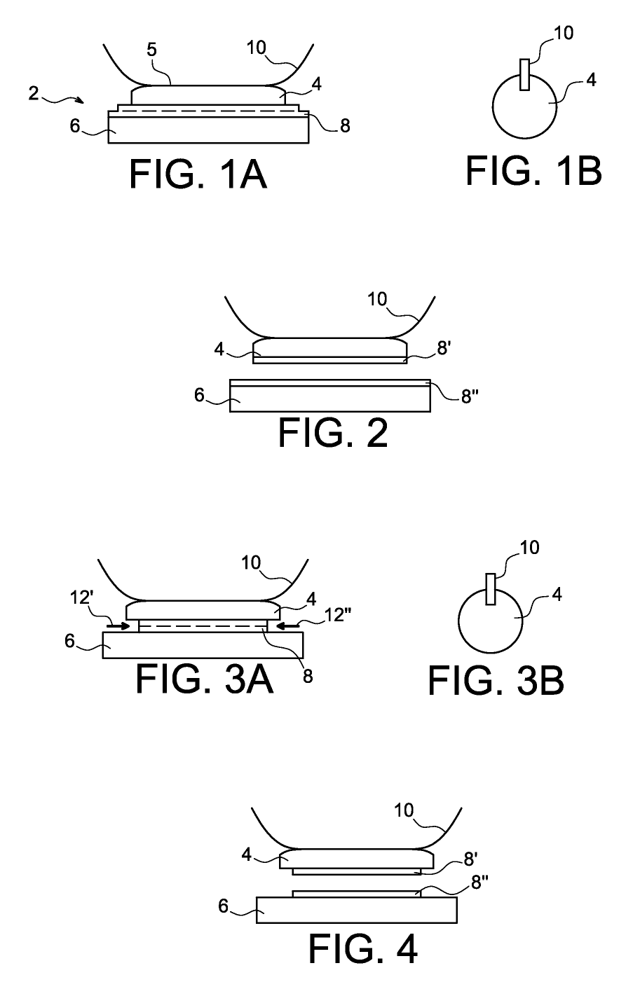

For purposes of illustration and not limitation, as embodied herein and as illustrated in FIG. 1A, a SeOl substrate is first selected, comprising a film or a membrane 4 of semiconductor material, such as silicon, Ge, SiC, or GaN. Membrane 4 can also include InP, LiNbO₃ or LiTaO₃. as desired. Membrane 4 can also include a piezoelectric material or a ferroelectric material. Membrane 4 can be a mono-layer or a multi-layer.

In accordance with a further aspect, whatever its nature, and whether it is a mono- or multi-layer, according to another variant, membrane 4 can include a processed layer. For example, membrane 4 can include holes, chips, circuits and/or micro-systems.

As further illustrated in FIG. 1A, substrate 6 is provided, and can include, for example, silicon, polysilicon or any other semiconductor material, as desired. If desired, a bonding interface 8 can be present between the two surfaces of the film or the membrane 4 and the substrate 6, the surfaces preferably being oxidised. In accordance with one alternative, the membrane 4 can be bonded to the substrate 6 by way of molecular adhesion.

Preferably, the bonding interface of the SeOl structure is prepared in such a way that it promotes the subsequent detachment of the upper membrane 4. For example, the surfaces brought into contact may undergo specific treatments in order to control the bonding energy, as described in a variety of references:

For example, in US 2004/222500, an interface is produced by molecular bonding between the face of a layer (herein the membrane 4) and the face of a substrate (herein the substrate 6). A treatment of at least one of these two faces is previously applied in such a way that the mechanical strength of the interface is controlled, and is compatible with subsequent detachment.

By way of further example, in FR 2 860 249, an intermediate layer (herein the layer 8), for example in PSG or in BPSG, is disposed at the interface of membrane 6 and substrate 4. This intermediate layer includes at least one base material in which extrinsic atoms or molecules, different from the atoms of the base material, are distributed, and in which a heat treatment is applied, for example at a temperature between 900° C. and 1100° C. The formation of microbubbles or microcavities, in particular of a gaseous phase, is thus produced in an irreversible manner, in such a way that the intermediate layer is transformed in a porous layer capable of increasing in thickness.

In US2005/029224, an interface is produced in order to have at least a first zone with a first level of mechanical strength and a second zone with a second level of mechanical strength much less than that of the first zone; this interface can be obtained by different means, for example by bonding of two surfaces prepared in a different way, or by a weakened embedded layer or by a porous intermediate layer.

In US 2006/019476, microbubbles or microcavities lead to the constitution of a weakened layer 8 at the interface between a thin layer of semiconductor material (for example the membrane 4) and a face of a substrate 6. Then, a heat treatment allows the increase of the weakening level.

In particular, documents US2004/222500 or US2006/019476 describe structures of the type D-BSOI™, or detachable structure SOI.

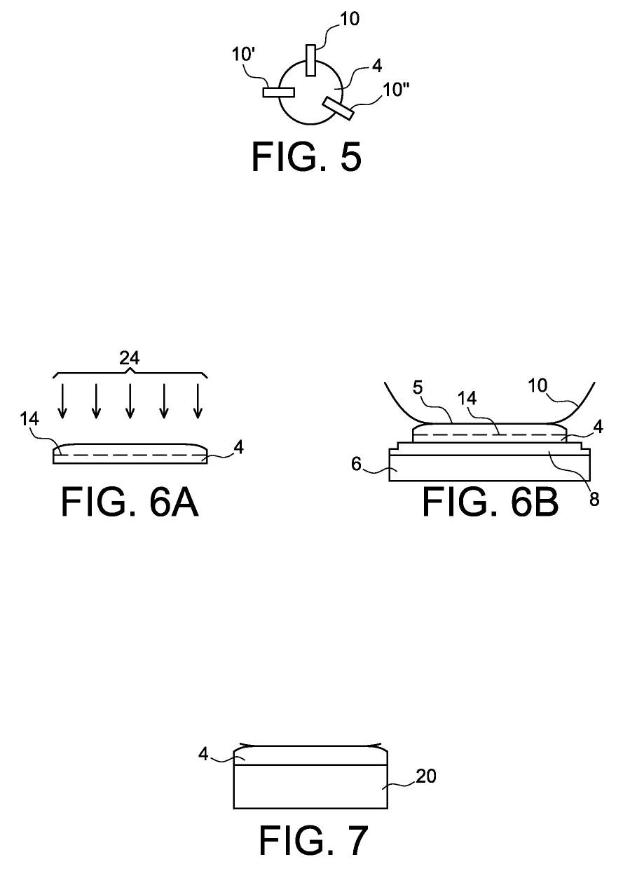

With further reference to FIG. 1, a member, such as an adhesive film 10 is applied on the surface 5 of the membrane 4 (i.e., the surface situated on the opposite side of the bonding interface 8). As discussed below with reference to FIG. 5, a plurality of films including adhesive 10, 10′, 10″ can be joined with surface 5. The contact surface between the film or the films 10, 10′, 10″ and the surface 5 of the membrane 4 to be detached is preferably selected in such a way that:

(1) The contact surface is sufficiently large for the film or films 10 to adhere to membrane 4 to be detached, and for the forces applied to the film(s) to be able to cause the detachment of this membrane,

(2) The contact surface is sufficiently small such that the deformation of the membrane 4 is compatible with the elasticity criteria of the membrane.

In accordance with one embodiment, a ratio, for example, between 2 and 50 or between 2 and 100, preferably between 10 and 50 or preferably between 10 and 20 exists between the surface 5 of the membrane 4 and the surface of the adhesive film(s) applied against this surface 5. Stated another way, the ratio of the surface area of the surface 5 of the membrane and the surface area of the adhesive film(s) applied against the surface 5 may be between about 2 and 50, between about 2 and 100, preferably between about 10 and 50, or between about 10 and 20.

FIG. 1B illustrates an embodiment of membrane 4 and an adhesive 10 in plan view. FIG. 5 represents an embodiment including a plurality of adhesives 10, 10′, 10″ with the membrane 4 in plan view. In the following description, the explanation and illustration will be restricted to the case of a single adhesive, but all the considerations presented in the case of a single adhesive can be equally apply to the case of a plurality of adhesives.

The separation of the membrane 4 can be initiated by the application of a force such as a tractive force, for example, on the adhesive 10. In the case of a plurality of adhesives, the traction can be applied to one or several adhesives. The membrane 4 is free, since it is only in contact with the adhesive film over a small area, and can thus be freely deformed. Thus, the stress and the deformation generated in the layer 4 are much weaker than with the method proposed in the prior art, which employs an adhesive over the whole area. The invention thus allows the detachment of the membrane 4 without rupturing it. FIG. 2 represents the membrane after separation, a layer 8′, 8″ of Si oxide remaining on each of parts 4, 6, for example in the case of a D-BSOI™ substrate prepared on the basis of an oxide/oxide bonding and executed in such a way that it is detachable, for example according to one of the previously mentioned techniques, or in such a way that the bonding interface has a controlled bonding energy in order that the substrate is detachable, according to one of the previously mentioned techniques.

The total contact area between the membrane 4 and the adhesive 10 depends on the elastic parameters of the adhesive, the nature of the membrane to be detached (weakly doped silicon, or strongly doped silicon, or AsGa, . . . ), the diameter of the substrate 6, the thickness of the membrane 4, and the bonding energy at the interface.

Thus, for a wafer 6 of diameter 150 mm for example, with a detachable layer 4 of thickness 50 microns, the contact area between adhesive 10 and the membrane 4 is of the order of 1 to 10 cm², preferably around 4 cm².

The higher the bonding energy between detachable the membrane 4 and the support 6, the greater the contact area, between the membrane and the adhesive(s), allowing the membrane 4 to be detached.

On the other hand, the contact area will also vary as a function of the shape of the contact (more or less wide rectangular shape, rounded shape . . . etc).

A variant will be described in connection with FIGS. 3A, 3B and 4. This variant employs the formation of an initiator.

As illustrated in FIG. 3A, the detachment of the membrane 4 can be facilitated by attacking the interface between the layers 8′, 8″ laterally, for example by a chemical attack with HF. This lateral attack is symbolised by the two arrows 12, 12′ in the FIG. 3A. The detachment is thus started, and the detachment of the membrane 4 can be done by exerting a weaker traction on the adhesive film 10. The risk of rupture of the membrane is thus reduced.

In the case of such lateral attack, it is also possible to limit the contact area between the adhesive 10 and the membrane 4.

FIG. 4 represents the membrane after separation, a layer 8′, 8″ of Si oxide remaining on each of parts 4, 6.

The performance of a method according to the invention is facilitated if the bonding interface (herein the interface 8) between the membrane 4 and the substrate 6 has a controlled energy.

Moreover, the nature of the material 8 eventually present at the interface between the substrate and the membrane 4 may be selected in such a way to lead to detachment of the membrane 4.

The control of the energy and/or the control of the nature of the material present at the interface to have a facilitated detachment are described for example in the documents already cited and commented on above, including US2004/222500, US2006/019476, FR0311450, or US2005/029224.

In all these cases, a weakened zone 14 can be produced in the membrane 4, by ionic or atomic implantation 24 in said membrane (FIG. 6A), then it is bonded to a support substrate 6 (FIG. 6B, which adopts numerical references identical to those of FIG. 1A) and the detachment of the membrane is realized via the adhesive film or films 10, 10′, 10″ along weakened zone 14; such a method can produce a separation of the membrane 4 with respect to the support 6. A part of the membrane 4 thus remains on the substrate 6. It is also possible to carry out the bonding of the membrane 4 with the support substrate 6 before the ionic or atomic implantation step into the membrane 4 and then, to realize the separation with the adhesive means.

In order to create the weakened zone, the Smart Cut® technique can be applied as described for example in the article by A. J. Auberton-Hervé et al. “Why can Smart-Cut change the future of microelectronics?” published in International Journal of High Speed Electronics and Systems, Vol. 10, N.1 (2000), p. 131-146.

The self-supporting membrane obtained by a method according to embodiments of the invention can be used without any other support or substrate.

As a variant, the self-supporting membrane can be transferred to another substrate 20, as illustrated in FIG. 7.

The methods and systems of the present invention, as described above and shown in the drawings, provide superior approaches of forming membranes. It will be apparent to those skilled in the art that various modifications and variations can be made in the devices and methods of the present invention without departing from the spirit or scope of the invention. Thus, it is intended that the present invention include modifications and variations that are within the scope of the appended claims and their equivalents.

What is claimed is:

1. A method for separating a membrane from a substrate, comprising:
a) applying at least one member to the membrane by way of an adhesive, wherein the adhesive is applied to substantially less than the entirety of the surface of said membrane which is not facing the substrate;
b) separating at least a part of the membrane from the substrate by applying a force to the at least one member.

2. The method of claim 1, wherein the membrane is initially bonded by molecular adhesion to the substrate.

3. The method of claim 1, wherein the membrane is initially bonded via a bonding layer to the substrate.

4. The method of claim 3, wherein the substrate includes a weakened zone therein.

5. The method of claims 1, wherein the membrane includes material selected from the group consisting of a semiconductor material, a piezoelectric material and a ferroelectric material.

6. The method of claim 1, wherein the membrane includes material selected from the group consisting of weakly doped silicon, strongly doped silicon, AsGa, Ge, SiC, GaN, InP, LiNbO₃ and LiTaO₃.

7. The method of claim 1, wherein the membrane is a mono-layered structure.

8. The method of claim 1, wherein the membrane is a multi-layered structure.

9. The method of claim 1, wherein the membrane includes a processed layer.

10. The method of claim 9, wherein the processed layer includes at least one of a hole, a chip, a circuit and a microsystem.

11. The method of claim 1, wherein the separation step includes a lateral attack to the interface between the membrane and substrate to facilitate separation.

12. The method of claim 11, wherein the lateral attack includes applying a chemical to the interface.

13. The method of claim 1, wherein the membrane has a thickness greater than three microns.

14. The method of claim 1, wherein the membrane is circular.

15. The method of claim 1, wherein the ratio of the entirety of the area of the surface of the membrane not facing the substrate to the surface area to which the adhesive is attached is between about 2 and about 50.

16. The method of claim 1, wherein the ratio of the entirety of the area of the surface of the membrane not facing the substrate to the surface area to which the adhesive is attached is between about 2 and about 100.

17. The method of claim 1, wherein the ratio of the entirety of the area of the surface of the membrane not facing the substrate to the surface area to which the adhesive is attached is between about 10 and about 50.

18. The method of claim 1, wherein the ratio of the entirety of the area of the surface of the membrane not facing the substrate to the surface area to which the adhesive is attached is between about 10 and about 20.

19. The method of claim 1, wherein the membrane is adapted and configured to be self-supporting after the separating step.

20. The method of claim 1, further comprising transferring the membrane onto a support after the separating step.

21. The method according to claim 1, wherein the membrane includes a weakened zone formed therein.

22. The method of claim 21, wherein the separating step takes place at least in part along the weakened zone.

23. The method of claim 21, wherein the weakened zone is produced by ionic or atomic implantation.

24. The method of claim 23, wherein the weakened zone is produced before bonding the membrane to the substrate.

25. The method of claim 1, wherein the interface between the membrane and the substrate has a controlled bonding energy to facilitate the separating step.

26. The method of claim 1, wherein the interface between the substrate and the membrane includes a material that is selected to facilitate the separating step.
